(19) United States
(12) Patent Application Publication
(10) Pub. No.: US 2024/0180070 A1
(43) Pub. Date: Jun. 6, 2024

(54) ELECTRIC UTILITY VEHICLE ECO-MODE SELECTION AND OPERATION

(71) Applicant: Ariens Company, Brillion, WI (US)

(72) Inventor: Clayton Van Thiel, Little Chute, WI (US)

(21) Appl. No.: 18/550,743

(22) PCT Filed: Dec. 15, 2022
(86) PCT No.: PCT/US2022/081710

§ 371 Date: Sep. 15, 2023

Related U.S. Application Data
(60) Provisional application No. 63/290,507, filed on Dec. 16, 2021.

(51) Int. Cl. A01D 34/00; A01D 34/66; A01D 34/78; A01D 69/02; A01D 101/00; B60L 1/00

(52) U.S. Cl. CPC A01D 34/006; A01D 34/78; A01D 69/02; B60L 1/003; A01D 34/66; A01D 2101/00; B60L 2200/40

(57) ABSTRACT

Systems and methods for implementing an eco-mode in an electric utility vehicle. One example system includes an electric utility vehicle comprising an electrically driven component. a user actuable input device, and an electronic processor. The electronic processor is configured to receive an input from the user actuable input device. The electronic processor is configured to determine, based on the input. an operational mode for the electric utility vehicle. The electronic processor is configured to operate the electrically driven component based on the operational mode to limit an amount of electrical power consumed by the electrically driven component.

### FIELD OF THE INVENTION

Embodiments and aspects presented herein relate to electrically driven lawn mowers and, in particular, to systems and methods for operating an electrically driver lawn mower in a power saving mode.

### SUMMARY

Electric utility vehicles (for example, electric or hybrid electric lawn mowers) use battery power to drive and operate cutting blades and other equipment. To increase runtime for such vehicles, an eco-mode is desirable, where reduced power is used for some operations of the vehicle. For example, it may be possible to reduce the power consumption of the cutting deck of a lawn mower while still providing adequate performance. While in an eco-mode, power may be reduced by changing blade tip speed and power distribution to the deck motors.

One example embodiment includes an electric utility vehicle. The electric utility vehicle comprising an electrically driven component, a user actuable input device, and an electronic processor. The electronic processor is configured to receive an input from the user actuable input device. The electronic processor is configured to determine, based on the input, an operational mode for the electric utility vehicle. The electronic processor is configured to operate the electrically driven component based on the operational mode to limit an amount of electrical power consumed by the electrically driven component.

Another example embodiment includes a method for operating an electric utility vehicle. The method includes receiving an input from a user actuable input device. The method includes determining, based on the input, an operational mode for the electric utility vehicle. The method includes operating an electrically driven component of the electric utility vehicle based on the operational mode to limit an amount of electrical power consumed by the electrically driven component.

Other aspects of the invention will become apparent by consideration of the detailed description and accompanying drawings.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is a diagram of an electric utility vehicle according to some embodiments.

FIG. 2 illustrates a side-view of the electric utility vehicle of FIG. 1 according to some embodiments.

FIG. 3 block diagram of a controller of the electric utility vehicle of FIG. 1 according to some embodiments.

FIG. 4 is a schematic circuit diagram of a user actuable input device of the utility vehicle of FIG. 1 according to some embodiments.

FIG. 5 is a flow chart of a method implemented by the controller of FIG. 3 according to some embodiments.

FIGS. 6A and 6B illustrate example graphical user interfaces presented by the controller of FIG. 3 according to some embodiments.

FIG. 7 is a graph illustrating aspects of the operation of the electric utility vehicle of FIG. 1 according to some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments illustrated.

The apparatus and method components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

### DETAILED DESCRIPTION

Before any aspects of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. For example, while embodiments are described herein in terms of a lawn mower, it should be understood that the systems and methods disclosed herein may be applied to other kinds of vehicles.

Also, it is to be understood that the phraseology and terminology used herein is for the purpose of description and should not be regarded as limiting. The terms “mounted,” “connected,” and “coupled” are used broadly and encompass both direct and indirect mounting, connecting, and coupling. Further, “connected” and “coupled” are not restricted to physical or mechanical connections or couplings, and can include electrical connections or couplings, whether direct or indirect. Also, electronic communications and notifications may be performed using any known means including wired connections, wireless connections, etc.

It should also be noted that a plurality of hardware and software-based devices, as well as a plurality of different structural components may be used to implement the examples and embodiments presented herein. Some embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one aspect, the electronic based aspects may be implemented in software (for example, stored on non-transitory computer-readable medium) executable by one or more electronic processors. Therefore, it should be noted that a plurality of hardware and software-based devices, as well as a plurality of different structural components may be utilized to implement the embodiments presented. For example, “control units” and “controllers” described in the specification can include one or more electronic processors, one or more memory modules including non-transitory computer-readable medium, one or more input/output interfaces, and various connections (for example, a system bus) connecting the components.

For ease of description, some of the example systems presented herein are illustrated with a single exemplar of each of its component parts. Some examples may not describe or illustrate all components of the systems. Other examples may include more or fewer of each of the illustrated components, may combine some components, or may include additional or alternative components.

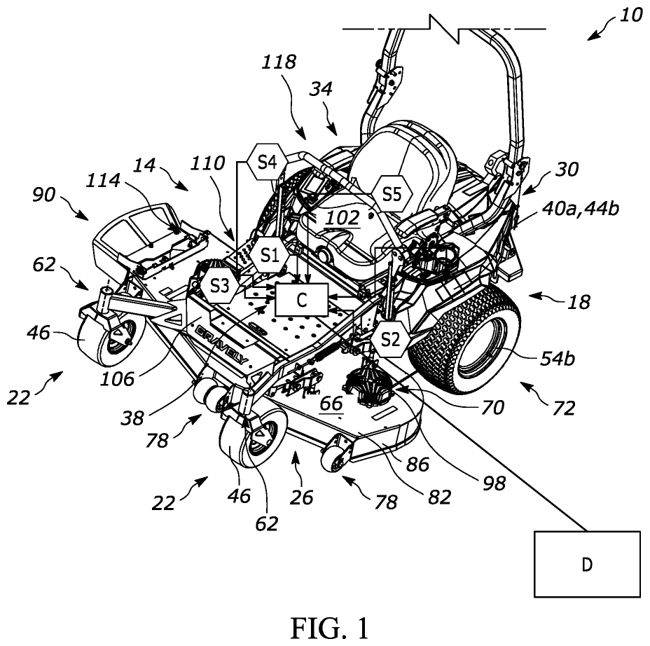

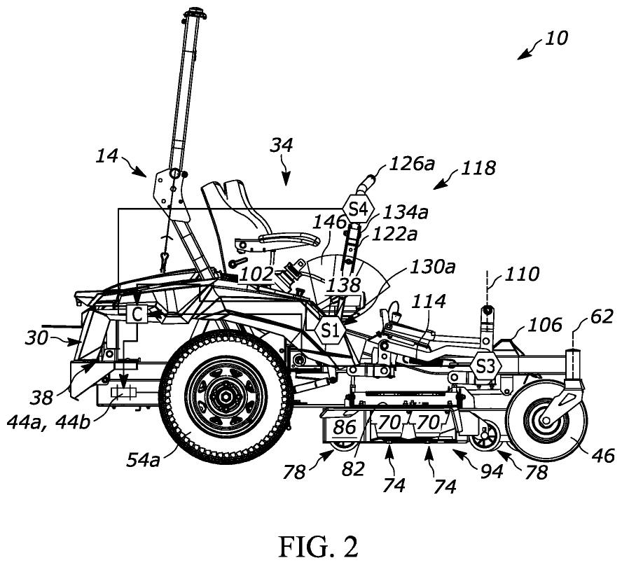

FIGS. 1 and 2 illustrate an electric utility vehicle 10. The utility vehicle 10 may be, for example, an electric zero-turn lawn mower or a hybrid lawn mower. The utility vehicle 10 includes a frame 14, a prime mover 18, a plurality of ground engaging elements 22, a cutting deck assembly 26, a power source 30, an operator zone 34, and a control system 38 including an electronic controller C. The frame 14 defines a basic body structure or chassis of the utility vehicle 10.

The prime mover 18 is mounted to the frame 14. The prime mover 18 may be, for example and without limitation, one or more electric motors or a hybrid gas/electric engine. In the illustrated embodiment, the prime mover 18 is or includes one or more electric drive motors 44a, 44b for transmitting torque to the ground engaging elements 22. The term “prime mover” is intended to cover all components of the drive system, including any necessary transmission.

The ground-engaging elements 22 support the frame 14. In the illustrated embodiment, the ground-engaging elements 22 are rotatable wheels, but in other embodiments the ground-engaging elements 22 could be tracks or other elements which move the utility vehicle 10 over a ground surface. The illustrated ground-engaging elements 22 include two front caster wheels 46 supporting a front portion of the frame 14 and two rear drive wheels 54a, 54b supporting a rear portion of the frame 14. The illustrated caster wheels 46 are passive (i.e., rotating in response to movement of the utility vehicle 10) and freely swivel about vertical axes 62. The illustrated rear drive wheels 54a, 54b are driven (i.e., rotating under power to cause movement of the utility vehicle 10) and may alternatively be referred to as driven elements (i.e., driven by the prime mover 18). Each of the drive wheels 54a, 54b is independently rotated by a dedicated one or more drive motors (for example, drive motors 44a, 44b) at a selected speed and direction to affect movement and steering of the utility vehicle 10 (for example, in the known manner of a zero-turn radius (ZTR) lawn mower). In the illustrated embodiment, the drive motors 44a, 44b are interconnected to the two rear drive wheels 54a, 54b through a transmission or gear train to increase speed or torque delivered to the drive wheels 54a, 54b. In alternative embodiments, the drive motors 44a, 44b may each include an output shaft which are directly coupled to one of the drive wheels 54a, 54b to independently drive rotation of the associated drive wheel 54a, 54b at a selected speed and direction. The drive wheels 54a, 54b may therefore be characterized as direct-drive wheels 54a, 54b with dedicated direct drive motors 44a, 44b.

The cutting deck assembly 26 includes a cutting deck 66, a plurality of deck motors 70, a plurality of blades 74, and a plurality of roller elements 78. The cutting deck 66 includes a generally horizontal top wall 82 and a depending side wall 86. A discharge opening or chute 90 is formed in the side wall 86, but otherwise the side wall 86 extends around the entire perimeter of the top 82 to define an enclosure 94 where grass cutting occurs. The illustrated deck motors 70 are electric deck motors mounted to the top wall 82, each including a shaft 98 extending vertically down through the top wall 82. At least one of the blades 74 is mounted to each shaft 98 to rotate under the influence of the deck motor 70 to cut grass within the enclosure 94. In the illustrated configuration, each blade 74 is directly driven by a deck motor 70. In some embodiments, a single deck motor 70 may be utilized to drive multiple blades 74. In some instances, the deck motors 70 are controlled by one or more electronic deck motor controllers (not shown), which control the power applied to the deck motors from the power source 30. The deck motor controllers are configured to individually control the speed (e.g., the revolutions per minute (RPMs) of the deck motor spindle) and power (e.g., the current consumed by the motors during operation) of the deck motors 70. The illustrated rollers 78 can be referred to as anti-scalping rollers that passively roll over the ground and support the cutting deck 66.

The power source 30 in the illustrated embodiment includes one or more batteries/battery packs. The power source 30 is electrically coupled to the one or more drive motors 44a, 44b and deck motors 70. The illustrated power source 30 is mounted to the rear portion of the frame 14 but may be positioned and/or dispersed across various points within the utility vehicle 10.

The operator zone 34 includes, among other things, an operator platform 102 and maneuvering controls 118. The zone 34 may also include a footrest 106 and/or a brake 110 for operating a braking system (not shown and, for sake of brevity not described herein) of the utility vehicle 10. The illustrated operator platform 102 is a seat on which the operator sits while operating the utility vehicle 10. In some embodiments, the utility vehicle 10, the operator platform 102 may include a standing platform on which the operator stands during operation. In further embodiments, the utility vehicle 10 is an upright, or walking, lawn mower with no seat for the operator. The operator zone 34 can be broadly defined as the operator platform 102 and all foot-operated and/or hand-operated controls within reach of the operator while at the operator platform 102. The footrest 106 provides a surface against which the operator's feet may rest or brace during operation of the utility vehicle 10.

The maneuvering controls 118 include left and right control arms 122a and left and right handles 126a. The left and right control arms 122a are pivotably mounted to the operator platform 102 or the frame 14. The control arms 122a may be levers, a steering column, or the like to control movement of the utility vehicle 10. The control arms 122a pivot forward and rearward about pivot joints 130a with respect to the operator platform 102. The left and right handles 126a pivot inward and outward (i.e., side-to-side, left and right) about pivot joints 134a with respect to the respective left and right control arms 122a. During operation, the user grasps the handles 126a and pivots the control arms 122a accordingly to operate the drive wheels 54a, 54b.

The control system 38 includes a controller C that is communicatively coupled to one or more of a plurality of electrical components/systems S1-S5 of the utility vehicle 10. The components/systems S1-S5 may include, for example, one or more of the prime mover 18, ground engaging elements 22, the cutting deck assembly 26 (e.g., one or more deck motor controllers), the power source 30, the operator zone 34, the braking system, and the like. The controller C is additionally communicatively coupled to a user actuable input device D. The device D may be any kind of actuable digital or analog input device. The device D may be, for example, a switch. In other embodiments, the device D is a foot pedal, a lever, a rotatable dial, selector switch, pushbutton, or the like. The components/systems S1-S5 may also include one or more types of sensors of the utility vehicle 10. Such sensors include, but are not limited to, one or more of a brake sensor, a control arm sensor, and/or a handle sensor.

The controller C and device D may be positioned/integrated anywhere on the utility vehicle 10, either in or not in the operator zone 34. The controller C, as explained in more detail below, electronically communicates (e.g., via wires or wirelessly) with the one or more components/systems S1-S5 and affects operation of the respective component/system S1-S5 based on a detected input from the user actuable input device D. In some embodiments, the controller C electronically communicates with the one or more components/systems S1-S5, as well as other components of the utility vehicle 10, using a communication bus (e.g., a Controller Area Network (CAN™) bus).

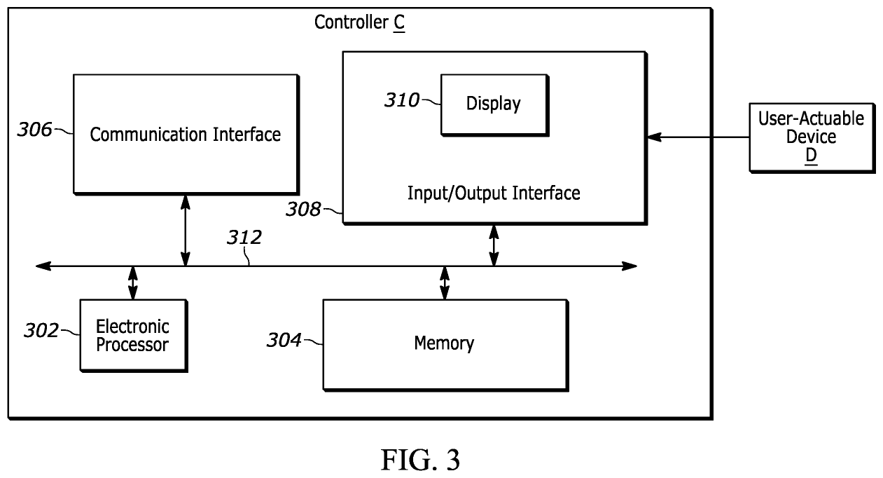

FIG. 3 is a schematic block diagram of the controller C according to some embodiments. The controller C, as illustrated, includes an electronic processor 302, a memory 304, a communication interface 306, and an input/output interface 308. The components of the controller C, along with other various modules and components are electrically coupled to each other by or through one or more control or data buses (for example, the bus 312), which enable communication therebetween. The use of control and data buses for the interconnection between, and communication among, the various modules and components would be known to a person skilled in the art in view of the examples described herein. In some instances, the bus 312 is a Controller Area Network (CAN™) bus. FIG. 3 illustrates only one example of the controller C. In alternative examples, the controller C may include fewer or additional components and may perform functions other than those explicitly described herein.

In some embodiments, the electronic processor 302 is implemented as a

microprocessor with separate memory, for example, the memory 304. In other embodiments, the electronic processor may be implemented as a microcontroller (with memory on the same chip). In other embodiments, the electronic processor 302 may be implemented using multiple processors. In addition, the electronic processor 302 may be implemented partially or entirely as, for example, a field-programmable gate array (FPGA), and application specific integrated circuit (ASIC), and the like and the memory may not be needed or be modified accordingly.

In the example illustrated, the memory 304 includes non-transitory, computer-readable memory that stores instructions that are received and executed by the electronic processor 302 to carry out functionality of the controller C described herein. The memory 304 may include, for example, a program storage area and a data storage area. The program storage area and the data storage area may include combinations of different types of memory, for example, read-only memory and random-access memory.

The communication interface 306 sends and receives electronic signals to and from the components within the controller C and other components of the utility vehicle 10. The communication interface 306 may include, for example, one or more transceivers. In some embodiments, the transceiver may be implemented as a single receiving and transmitting unit or comprise a separate transmitter and receiver.

The input/output interface 308 includes or is in communication with one or more input mechanisms such as pushbuttons, knobs, and the like (for example, the device D and any of the one or more components/systems S1-S5 of the utility vehicle 10). The input/output interface 308 may include one or more output mechanisms (for example, a display, a light, a speaker, and the like), or a combination thereof. The input/output interface 308 receives input from one or more components of the utility vehicle 10 (for example, input devices actuated by a user) and provides output to one or more components of the utility vehicle 10. The input/output interface 308 may include one or more sensors (for example, those described above regarding the utility vehicle 10) utilized by the electronic processor 302 to determine one or more states of one or more components of the utility vehicle 10. As shown in the illustrated example, the input/output interface 308 includes an electronic display 310.

Some or all of the components of the controller C may be integrated/positioned at various locations throughout the utility vehicle 10. The electronic processor 302, for example, may be part of a display device (e.g., a dashboard or control panel) of the operator zone 34. In some embodiments, the controller C (and the electronic processor 302) are or are part of the vehicle control module (VCM), not shown, of the utility vehicle 10. In some instances, the electronic processor 302 may be configured to communicate with a vehicle control module (VCM), not shown, of the utility vehicle 10.

As described herein, the controller C (in particular, the processor 302) is configured to receive/read an input from the user actuable input device D. Based on the input, the electronic processor 302 selects a mode in which to operate one or more components/systems of the utility vehicle 10. In some aspects, based on an actuable state/position of the device D, the controller C operates the one or more components in a standard mode or an eco-mode. In the standard operational mode, the one or more components are operated at standard (for example full) operational power, whereas in the eco-mode, power consumed by/provided to one or more components from the power source 30 is reduced according to one or more predetermined values stored at the controller C by adjusting an operational characteristic of the respective component. For example, the controller C adjusts an operational characteristic (for example, a power supply/consumption and/or speed) of one or more components of the utility vehicle 10 (for example, one or more of the deck motors 70 and/or controllers of the utility vehicle 10). The controller C may do this by adjusting the power and/or speed to the one or more motors of the utility vehicle 10 to a predetermined value according to the mode indicated by the actuable state of the device D.

As described herein, the controller C may also be configured to operate the utility vehicle 10 in one of multiple different eco-modes. In some embodiments, the device D has more than two actuable positions and the controller C, based on the position selected by an operator, may select from more than one eco-mode/set of predetermined values. In some aspects, the predetermined values may be user selected. In some aspects, the predetermined values represent maximum values allowable for the operational characteristics of a component (e.g., a maximum power (e.g., a maximum current draw in amperes), a maximum speed in RPM, a maximum duty cycle, and the like). The respective predetermined values may be an actual value or a stored percentage and may be electronically stored (for example, within the memory 304) in a look-up table. In some aspects, the particular predetermined values, corresponding to the respective eco-mode, for the one or more components of the utility vehicle 10, are selected depending on the actuable state of the user actuable input device D. The controller C may provide an indication (haptic, visual, audio) to the operator of the utility vehicle 10 (for example, on the display 310) to indicate a current operational mode of the utility vehicle 10.

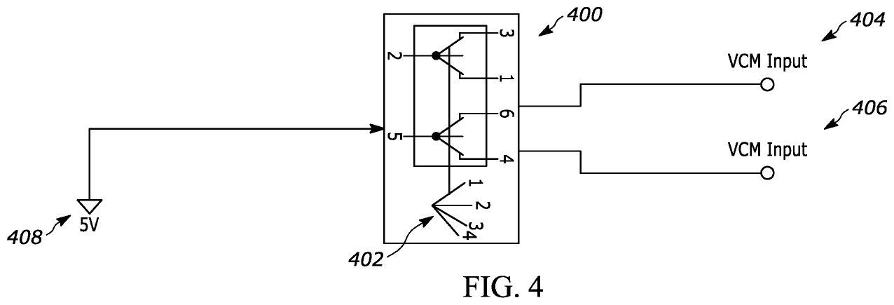

FIG. 4 is a circuit diagram of one example of the user actuable input device D. In the illustrated example, the switch 400 has four actuable positions 402, each of which being indicated to the controller C via voltage levels present on VCM input 404 and VCM input 406. In the illustrated example, the switch 400 receives a voltage 408 (e.g., 5V) and selectively couples it to the VCM input 404 and the VCM input 406 according to which of the four actuable positions 402 is selected by an operator. Each of the actuable positions corresponds to a respective operational mode of the utility vehicle 10. As described herein, the controller C operates the utility vehicle 10 based on the selected mode (e.g., via the operator actuating the device D to a particular actuable state). It should be noted that FIG. 4 illustrates only one example of the user actuable input device D. In some instances, the user actuable input device D may be a virtual device (e.g., presented as part of a graphical user interface on the display 310).

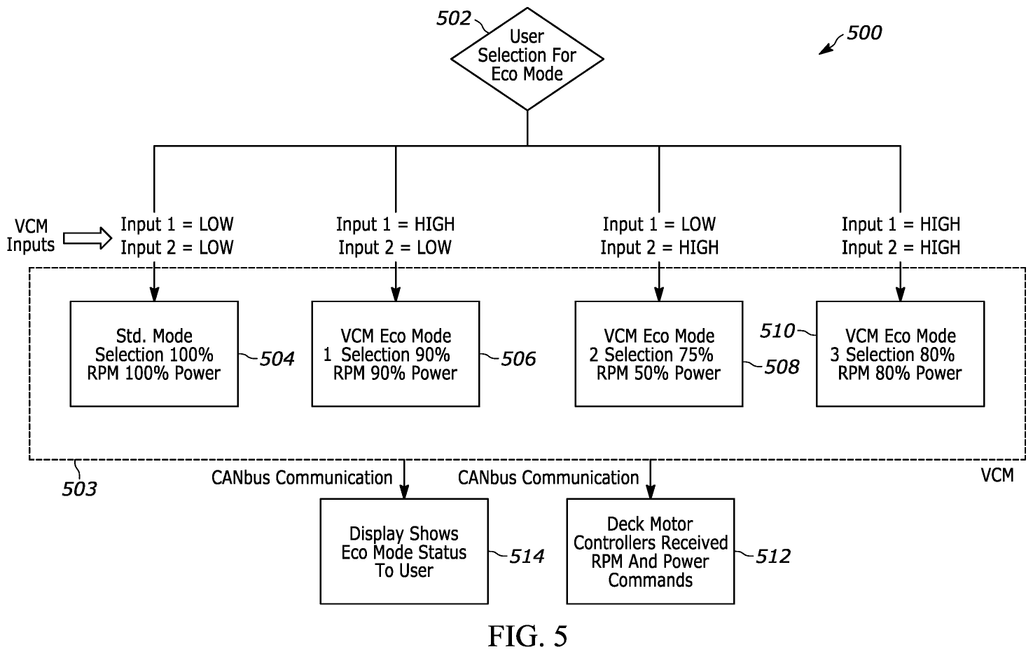

In some instances, the user actuable input device D is used to choose between four operational modes: a standard operation mode and one of three eco-modes. In this example, the operational modes refer to the operation of the deck motor or motors of the utility vehicle 10. In other examples, operational modes may also refer to the operation of the prime mover and/or one or more electrically driven components of the utility vehicle 10. FIG. 5 is a flow diagram 500 illustrating aspects of the operation of the utility vehicle 10. At block 502, an operator of the utility vehicle 10 makes a mode selection using the user actuable input device D. Depending on the selection made, the VCM inputs 404, 406 are set to a digital high or a digital low input value (e.g., a voltage of 5V being high and a voltage of 0V being low). In the example illustrated in FIG. 5, VCM input 404 is Input 1 to the VCM and VCM input 406 is Input 2 to the VCM 503. In some instances, the VCM 503 illustrated in FIG. 5 is an embodiment of the controller C. In other instances, the VCM 503 is another electronic controller coupled to the controller C and configured to receive the Inputs 1 and 2. As two inputs each having two potential states results in four different combinations, the VCM 503 is configured to read Inputs 1 and 2 and choose from among the four operational modes by mapping each of the four combinations to one of the four operational modes.

In the example illustrated, when both Input 1 and Input 2 are low, the standard operational mode is selected. In one example, in the standard operational mode, the blade tip speed (e.g., expressed in RPM of the motor spindle) and power settings (e.g., maximum current draw) for the deck motors are set to 100% of the values otherwise called for by the VCM 503 and communicated to the deck motor controllers by the VCM 503 (e.g., via a CAN bus). For example, an operator input may indicate a particular cutting speed, sensors may indicate to the VCM 503 that a particular power level should be used, and the speed of the utility vehicle 10 produced by prime mover 18 may be used to determine the speed and power settings for the deck motors 70. Regardless of how the VCM 503 determines the speed (RPM) and power (current) settings for the deck motors 70, those settings are issued as commands to the deck motor controllers at 100% of the determined values while the Inputs 1 and 2 indicate the standard operating mode.

In the example illustrated, when Input 1 is high and Input 2 is low, the first eco-mode is selected. While in an eco-mode, the VCM will command the deck motor controllers to operate at a VCM-defined percentage of the otherwise determined speed and power settings. While in the first eco-mode, the VCM changes the speed and power settings to 90% of their ordinary values before those settings are issued as commands to the deck motor controllers.

In the example illustrated, when Input 1 is low and Input 2 is high, the second eco-mode is selected. While in the second eco-mode, the VCM 503 changes the speed setting to 75% of its ordinary value and changes the power setting to 50% its ordinary value, prior to those settings being issued as commands to the deck motor controllers.

In the example illustrated, when both Inputs 1 and 2 are high, the third eco-mode is selected. While in the third eco-mode, the VCM 503 changes the speed and power settings to 80% of their ordinary values before those settings are issued as commands to the deck motor controllers.

In some instances, the VCM 503 is configured to control the power to the deck motors 70 by specifying a maximum current draw (e.g., in amperes) rather than a percentage.

As illustrated in FIG. 5, in some instances, (at block 512) the resulting speed and power commands are placed on a CAN bus, where the motor controllers read the commands and operate the deck motors 70 accordingly. In some instances, e.g., where the deck motor controllers determine their speed and power settings independently of the VCM 503, the VCM 503 (at block 512) the maximum speed and power settings are placed on the CAN bus by the VCM 503 for use by the deck motor controllers. For example, the deck motor controllers may determine an RPM setting and then alter that setting based off of a percentage value message placed on the CAN bus because an eco-mode was set by the VCM 503.

In some instances, the VCM 503 is configured to verify that the operational characteristics of the deck motors 70 and the motor controllers are properly adjusted to the respective predetermined values of the selected operational mode. For example, the VCM 503 may receive sensor data or use other means to determine the present speed and power draw of the deck motors.

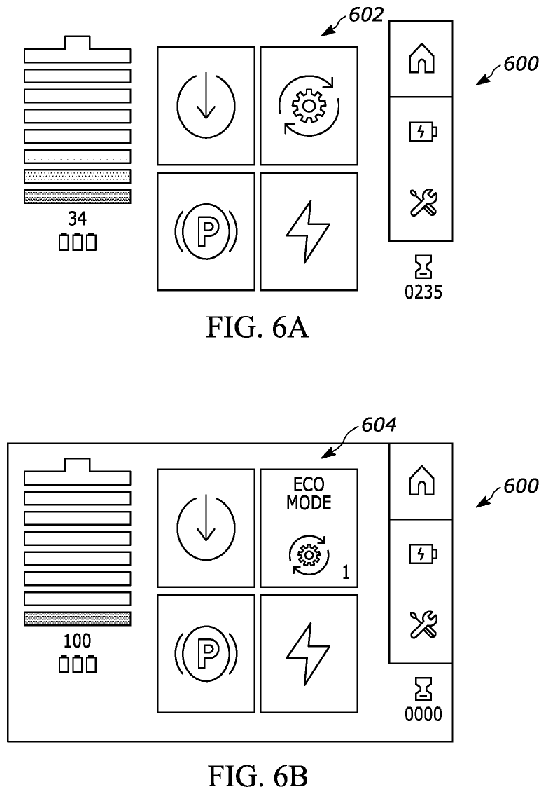

In some instances, the VCM 503 is configured to display a graphical indication (e.g., an icon) of the selected mode to an operator of the utility vehicle (e.g., on the display 310). In some instances, the VCM 503 controls the display directly. In other instances, the VCM 503 uses CAN bus communications (at block 514) to trigger a display to indicate the selective (and currently active) operational mode. For example, as illustrated in FIG. 6A, an example graphical user interface 600 is presented. The interface includes a graphical indicator 602 showing that the utility vehicle 10 is operation in standard operational mode. In some instances, this is the default display. FIG. 6B illustrates the interface 600 where eco-mode 1 is selected. As illustrated in FIG. 6B, the VCM 503 causes the display of a graphical indicator 604 while the first eco-mode is selected. In some instances, the display will only indicate an eco-mode while the deck motor controllers are actively controlling deck motors.

In some alternative embodiments, the device D may be a multi-position analog switch. For example, an analog position switch may be configured to provide outputs (and thus inputs to the controller) of between 4V and 5V, between 3V and 3.9V, between 2V and 2.9V, and 1V and 1.9V, and between 0V and 0.9V. Each of these analog voltage ranges, when received as an analog input to the controller, may be mapped to a different operational mode, as described above.

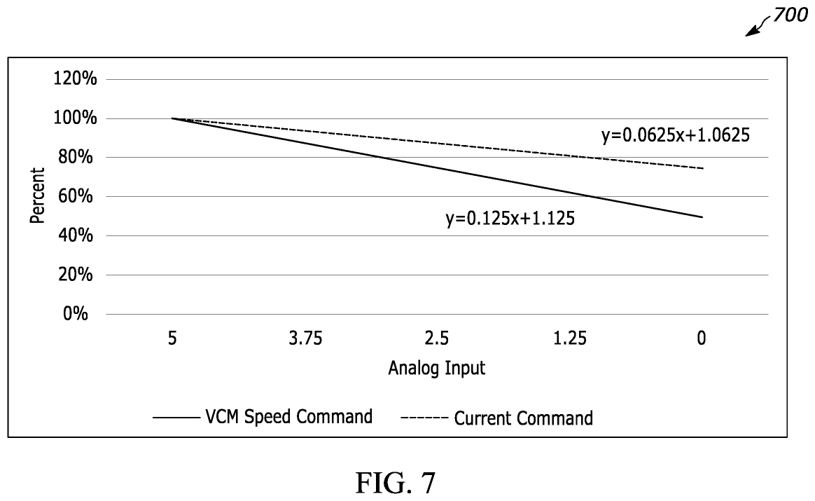

In some alternative embodiments, the device D may be a variable output analog switch (e.g., a potentiometer) configured to variably output voltages over a range (e.g., between 0V and 5V). In some instances, a controller receiving the variable analog voltage as an input may apply speed and current limitations variably according to a linear relationship (as illustrated in FIG. 7) to provide for a variable eco-mode. In the example illustrated in FIG. 7, a voltage of 5V results in a 100% adjustment for both speed and power (i.e., the standard operational mode). As such, a voltage of less than 5V results in the utility vehicle 10 being operated in an eco-mode. In this example, where the controller reads an input voltage of less than 5V, it would determine the appropriate adjustments to the speed and power settings, communicate those adjustments to the deck motor controllers, and cause the display to indicate an eco-mode.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but may also be configured in ways that are not listed.

What is claimed is:

1. An electric utility vehicle comprising:
an electrically driven component;
a user actuable input device; and
an electronic processor configured to:
receive an input from the user actuable input device;
determine, based on the input, an operational mode for the electric utility vehicle; and
operate the electrically driven component based on the operational mode to limit an amount of electrical power consumed by the electrically driven component.

2. The electric utility vehicle of claim 1, further comprising:
an electronic display coupled to the electronic processor, wherein the electronic processor is further configured to control the electronic display to, responsive to receiving the input, present a graphical indicator based on the operational mode.

3. The electric utility vehicle of claim 1, wherein the electronic processor is further configured to:
determine a maximum value for an operational characteristic of the electrically driven component based on the operational mode; and
operate the electrically driven component based on the operational mode by issuing commands based on the maximum value to a controller for the electrically driven component.

4. The electric utility vehicle of claim 3, wherein the electronic processor is further configured to determine a maximum value by determining one of a maximum speed or a maximum power.

5. The electric utility vehicle of claim 3, wherein the electronic processor is further configured to issue commands to the controller by sending a message on a communication bus of the electric utility vehicle.

6. The electric utility vehicle of claim 1, wherein the input from the user actuable input device is one selected from the group consisting of a digital high input, a digital low input, an analog voltage range, and a variable analog voltage.

7. The electric utility vehicle of claim 1, wherein the electrically driven component is an electric deck motor.

8. The electric utility vehicle of claim 1, wherein the operational mode is one selected from the group consisting of a standard mode and an eco-mode.

9. A method for operating an electric utility vehicle, the method comprising:
receiving an input from a user actuable input device;
determining, based on the input, an operational mode for the electric utility vehicle; and
operating an electrically driven component of the electric utility vehicle based on the operational mode to limit an amount of electrical power consumed by the electrically driven component.

10. The method of claim 9, further comprising:
controlling an electronic display of the electric utility vehicle to, responsive to receiving the input, present a graphical indicator based on the operational mode.

11. The method of claim 9, further comprising:
determining a maximum value for an operational characteristic of the electrically driven component based on the operational mode; and
operating the electrically driven component based on the operational mode by issuing commands based on the maximum value to a controller for the electrically driven component.

12. The method of claim 11, wherein determining a maximum value includes determining one of a maximum speed or a maximum power.

13. The method of claim 11, wherein issuing commands to the controller includes sending a message on a communication bus of the electric utility vehicle.

14. The method of claim 9, wherein receiving the input from the user actuable input device includes receiving one selected from the group consisting of a digital high input, a digital low input, an analog voltage range, and a variable analog voltage.

15. The method of claim 9, wherein operating the electrically driven component includes operating an electric deck motor.

16. The method of claim 9, wherein the operational mode is one selected from the group consisting of a standard mode and an eco-mode.
